(19) United States
(12) Patent Application Publication
(10) Pub. No.: US 2026/0251007 A1
(43) Pub. Date: Aug. 27, 2026

(54) INSULATED GLASS SPACER ADAPTED TO ACCOMMODATE GLASS EDGE DEFLECTION

(71) Applicant: Tecnoglass, Inc., Miami, FL (US)

(72) Inventor: Radu Florian Stancescu, Atlantic City, NJ (US)

(21) Appl. No.: 19/545,692

(22) Filed: Feb. 20, 2026

Related U.S. Application Data
(60) Provisional application No. 63/761,769, filed on Feb. 21, 2025.

(51) Int. Cl. E06B 3/663

(52) U.S. Cl. CPC E06B 3/66352; E06B 3/66323; E06B 3/66361; E06B 2003/6638; E06B 2003/66385; E06B 2003/66395

(57) ABSTRACT

An insulated glass unit spacer assembly includes a spacer body having a first and second side wall portion respectively at a first and second side of the spacer body, wherein the first and second side wall portions respectively define a first and second channel, a first side sealing member located within the first channel and configured to sealingly affix the first side wall portion to a first glass pane, and a second side sealing member located within the second channel and configured to affix the second side wall portion to a second glass pane; wherein both of the first and second side sealing member include a first and second side sealing member flange each extending in opposite directions from a side sealing member body; and wherein a first thickness of each first side sealing member flange is less than a second thickness of each second side sealing member flange.

### CROSS REFERENCE TO RELATED APPLICATIONS

The present application claims priority to U.S. Provisional Application No. 63/761,769, filed Feb. 21, 2025, which is hereby incorporated by reference herein in its entirety.

### TECHNICAL FIELD

The present disclosure generally relates to insulated glass window or door systems, and more particularly, to a spacer used in an insulated glass unit, such as a window or door panel.

### BACKGROUND

Many insulated glass units (IGUs) utilize spacers and sealants to maintain the integrity of the sealed air or gas-filled cavity that provides thermal and acoustic insulation between opposing panes of glass in the IGU. Traditional spacers are limited in their ability to accommodate glass deflection beyond the L/175 industry standard, often leading to loss of sealing, reduced insulation performance, and durability issues. Furthermore, if moisture penetrates the primary sealing barrier, the moisture can accumulate inside the cavity, causing interior condensation. This condensation not only degrades the performance of the IGU, but also affects the aesthetics of the insulated glass.

Thus, improvements in a spacer for an IGU are desired.

### SUMMARY

The following presents a simplified summary of one or more aspects to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In some aspects, the present disclosure relates to an insulated glass unit spacer assembly, including: a spacer body having a first side wall portion at a first side of the spacer body and a second side wall portion at a second side of the spacer body, wherein the first side wall portion defines a first channel and wherein the second side wall portion defines second channel; a first side sealing member located within the first channel and configured to sealingly affix the first side wall portion to a first glass pane; and a second side sealing member located within the second channel and configured to affix the second side wall portion to a second glass pane; wherein both of the first side sealing member and the second side sealing member include a first side sealing member flange and a second side sealing member flange each extending in opposite directions from a side sealing member body; and wherein a first thickness of each first side sealing member flange is less than a second thickness of each second side sealing member flange.

In some aspects, the present disclosure relates to an insulated glass unit, including: a first glass pane; a second pane; a spacer assembly sealingly connecting the first glass pane and the second glass pane, wherein the spacer assembly includes: a spacer body having a first side wall portion at a first side of the spacer body and a second side wall portion at a second side of the spacer body, wherein the first side wall portion defines a first channel and wherein the second side wall portion defines second channel; a first side sealing member located within the first channel and sealingly affixed between the first side wall portion and the first glass panel; and a second side sealing member located within the second channel and sealingly affixed between the second side wall portion and the second glass panel; wherein both of the first side sealing member and the second side sealing member include a first side sealing member flange and a second side sealing member flange each extending in opposite directions from a side sealing member body; and wherein a first thickness of each first side sealing member flange is less than a second thickness of each second side sealing member flange.

Additional aspects of the present disclosure are described in more detail below.

### BRIEF DESCRIPTION OF THE DRAWINGS

In the drawings, a common reference number used throughout the figures indicates the same or a similar component or feature.

FIG. 1 is an enlarged front perspective view of a portion of an insulated glass unit, as indicated by dashed lines in an inset front view, having a spacer assembly configured to enable enhanced glass deflection.

FIG. 2 is an exploded view of the portion of the insulated glass unit, including the spacer assembly, of FIG. 1.

FIG. 3 is a left side view of the portion of the insulated glass unit, including the spacer assembly, of FIG. 1.

FIG. 4 is a top view of the portion of the insulated glass unit, including the spacer assembly, of FIG. 1.

FIG. 5 is a left side view of the spacer body of the spacer assembly of FIG. 1. The right side view is identical.

FIG. 6 is a front view of the spacer body of the spacer assembly of FIG. 1. The rear view is identical.

FIG. 7 is a top view of the spacer body of the spacer assembly of FIG. 1.

FIG. 8 is a left side view of the first or second side sealing member of the spacer assembly of FIG. 1. The right side view is a mirror image.

FIG. 9 is a front view of the first or second side sealing member of the spacer assembly of FIG. 1.

FIG. 10 is a top view of the first or second side sealing member of the spacer assembly of FIG. 1.

FIG. 11 is a left side view of the outside sealing member of the spacer assembly of FIG. 1. The right side view is identical.

FIG. 12 is a front view of the outside sealing member of the spacer assembly of FIG. 1. The rear view is identical.

FIG. 13 is a top view of the outside sealing member of the spacer assembly of FIG. 1.

FIG. 14 is an enlarged front perspective view of a portion of an insulated glass unit, as indicated by dashed lines in an inset front view, having another example of a spacer assembly configured to enable enhanced glass deflection.

FIG. 15 is an exploded view of the portion of the insulated glass unit, including the spacer assembly, of FIG. 14.

FIG. 16 is a left side view of the portion of the insulated glass unit, including the spacer assembly, of FIG. 14.

FIG. 17 is a top view of the portion of the insulated glass unit, including the spacer assembly, of FIG. 1.

FIG. 18 is a left side view of the spacer body of the spacer assembly of FIG. 14. The right side view is identical.

FIG. 19 is a front view of the spacer body of the spacer assembly of FIG. 14. The rear view is identical.

FIG. 20 is a top view of the spacer body of the spacer assembly of FIG. 14.

FIG. 21 is a left side view of the spacer insert of the spacer assembly of FIG. 14. The right side view is identical.

FIG. 22 is a front view of the spacer insert of the spacer assembly of FIG. 14. The rear view is identical.

FIG. 23 is a top view of the spacer insert of the spacer assembly of FIG. 14.

### DETAILED DESCRIPTION

Various aspects of the disclosure are now described with reference to the drawings, wherein like reference numerals are used to refer to elements throughout. In the following description, for purposes of explanation, numerous specific details are set forth to promote a thorough understanding of one or more aspects of the disclosure. It may be evident in some or all instances, however, that any aspects described below can be practiced without adopting the specific design details described below.

Aspects of the disclosure include a spacer assembly for insulated glass units (IGUs) comprised of insulated glass panels that accommodate unsupported glass edge deflection beyond the L/175 glass industry standard while maintaining the integrity, performance, and/or durability of the sealed cavity. The geometry of the spacer assembly described herein is designed to maintain sufficient and permanent contact between primary and secondary sealant members and the adjacent glass panes, even during significant deflection, ensuring that the insulated cavity between the glass remains sealed. Furthermore, in some aspects, the spacer assembly may incorporate a desiccant to absorb moisture, such as from the initial sealing of the cavity at the production plant and/or to eliminate the risk of interior condensation during the life span. This innovative design of the spacer assembly is suitable for both double-glazed and triple-glazed IGUs with monolithic or multiple laminated glass panels, ensuring long-term thermal and acoustic insulation performance.

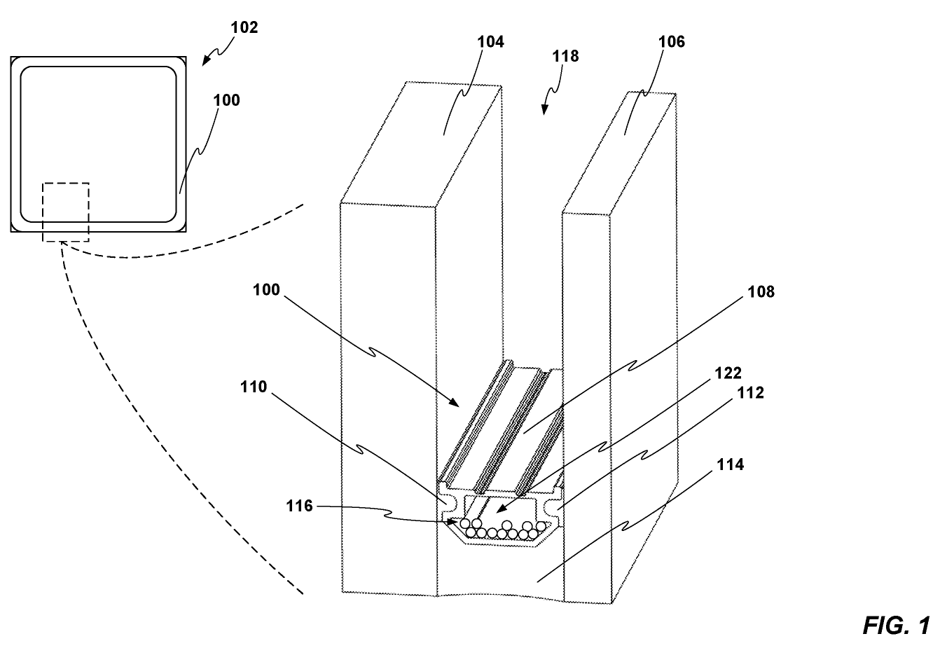

Referring to FIGS. 1-4, in one example, a spacer assembly 100 running along the outer edges of an insulated glass unit 102 is sealingly affixed between a first glass pane 104 and a second glass pane 106, wherein the spacer assembly 100 is configured to allow enhanced glass edge deflection, relative to existing solutions, while maintaining the integrity, performance, and/or durability of the sealed cavity 118 defined between the first glass pane 104 and the second glass pane 106. For example, the spacer assembly 100 may accommodate an amount of glass edge deflection that exceeds the L/175 glass industry standard, e.g., greater than 0.925 inches of edge deflection. While the insulated glass unit 102 described herein includes a single spacer assembly 100 and the first and second glass panes 104 and 16, thereby defining a double-paned or double-glazed insulated glass unit, it should be understood that the insulated glass unit 102 may include additional spacer assemblies and glass panes, such as but not limited to a second spacer and a third glass pane, thereby defining a triple-paned or triple-glazed insulated glass unit.

The spacer assembly 100 includes a spacer body 108 onto which is sealingly mounted at least a first side sealing member 110 configured to sealingly connect to the first glass pane 104 and a second side sealing member 112 configured to sealingly connect to the second glass pane 106. In an aspect, the first side sealing member 110 and the second side sealing member 112 are mirror images of one another, and/or are duplicate parts rotated 180 degrees relative to one another (e.g., about an axis perpendicular to their longitudinal length). Additionally, in some aspects, the spacer assembly 100 may further include an outside sealing member 114 positioned adjacent to the first side sealing member 110 and the second side sealing member 112, opposite the cavity 118, and configured to sealingly connect at least the first glass pane 104 and the second glass pane 106, and optionally also the spacer body 108. In other words, by being sealingly connected or affixed, the first side sealing member 110 and the second side sealing member 112, and, optionally, the outside sealing member 114, each provide a seal between the first glass pane 104 or the second glass pane 106 and the spacer body 108, and/or between the first glass pane 104 and the second glass pane 106, and/or between the first glass pane 104, the spacer body 108, and the second glass pane 106, wherein the seal resists or prevents moisture or other contaminants from entering into the sealed cavity 118 between the first and second glass panes 104 and 106. In further optional aspects that may be combined with any of the previously mentioned aspects, the spacer assembly 100 may additionally include a desiccant 116 within a spacer body inner chamber 122 defined in the spacer body 108 and exposed via openings in the spacer body 108 to an air or gas contained within the cavity 118 in order to absorb any moisture located within the cavity 118. The desiccant 116 includes any hygroscopic or moisture-absorbing substance configured to remove moisture from the sealed cavity 118 of the insulated glass unit 102. Suitable desiccants 116 include, but are not limited to, silica gel (including indicating and non-indicating varieties), molecular sieves (such as 3A, 4A, or 13X types), activated alumina, calcium oxide, calcium chloride, zeolites, bentonite clay, montmorillonite clay, and any other moisture-absorbing material or combination thereof. The desiccant 116 may be provided in various forms including beads, pellets, granules, powder, sheets, strips, or integrated into a matrix material.

As will be discussed below in more detail, the design of the first side sealing member 110 and the second side sealing member 112, and, optionally, the corresponding side walls of the spacer body 108, enable the enhanced glass edge deflection capability of the insulated glass unit 102 provided by the spacer assembly 100. In other words, at least the first side sealing member 110 and the second side sealing member 112 are configured to provide a dynamic movement mechanism to accommodate glass edge deflection beyond International Building Code (IBC) L/175 standards without compromising a sealing integrity of the cavity 118 between the first glass pane 104 and the second glass pane 106. The dynamic movement mechanism provided by the first side sealing member 110 and the second side sealing member 112 includes any structural arrangement, material property, or combination thereof that permits relative movement between components of the spacer assembly 100 in response to glass pane deflection of one and/or both glass panes 104, 106 while maintaining sealing integrity. The dynamic movement mechanism may include, without limitation, flowable or deformable sealing materials, compliant flanges, sliding interfaces, articulating joints, elastomeric connections, flexible mounting arrangements, or any other configuration that accommodates relative displacement between the spacer body 108 and the glass panes 104, 106 without loss of seal. The mechanism enables the spacer assembly 100 to maintain sealing contact during thermal expansion, contraction, wind loading, barometric pressure changes, and other forces that cause glass deflection.

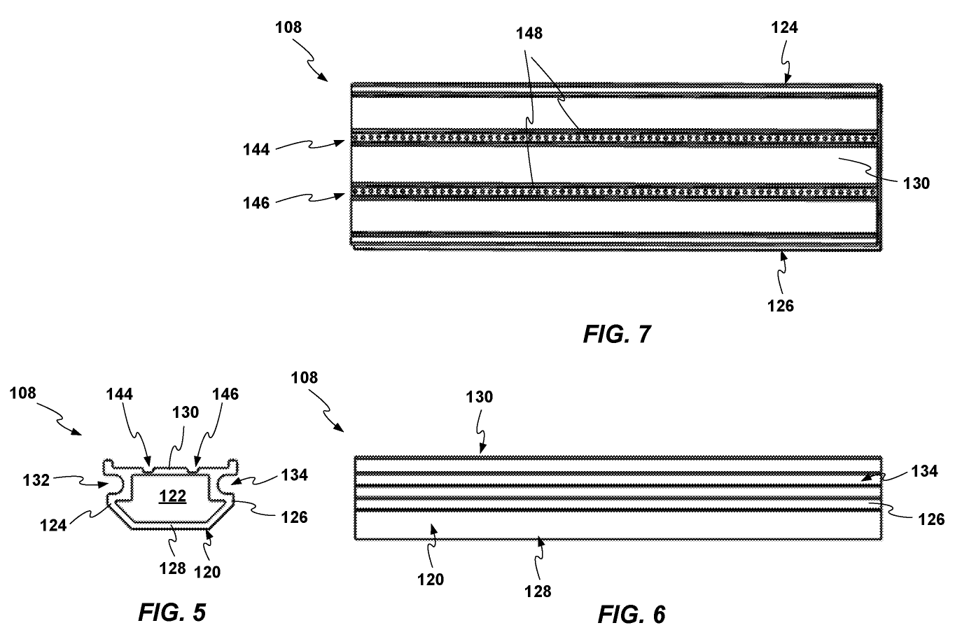

Additionally referring to FIGS. 5-7, the spacer body 108 includes a spacer body outer wall 120 that defines spacer body inner chamber 122, which is optionally configured to contain the desiccant 116. Additionally, the spacer body outer wall 120 further includes a first side wall portion 124 facing the first glass pane 104 and having a recessed portion that defines a first channel 134 configured to receive the first sealing member 110. Similarly, the spacer body outer wall 120 further includes a second side wall portion 126 facing the second glass pane 106 and having a recessed portion that defines a second channel 134 configured to receive the first sealing member 110. Further, the spacer body outer wall 120 also includes a bottom wall portion 128 facing an exterior of the insulated glass unit 102, and an opposing top wall portion 130 facing the cavity 118 between the first glass pane 104 and the second glass pane 106. In some aspects, the bottom wall portion 128 and/or the top wall portion 130 may include a plurality of non-straight, undulating, ridged, and/or curved sections, which lengthens a path of thermal conductivity, thereby reducing thermal transfer between the first and second glass panes 104 and 106 relative to a substantially straight wall design. The spacer body 108 refers to any structural element or frame configured to maintain a separation between two or more glass panes 104, 106 in the insulated glass unit 102. The spacer body 108 may take various forms including, but not limited to, a unitary extruded profile, a multi-piece assembled frame, a hollow or solid member, or a composite structure. The spacer body 108 may have any suitable cross-sectional shape including rectangular, trapezoidal, U-shaped, I-shaped, planar, or irregular profiles. While the illustrated aspects show a particular configuration, the spacer body 108 can encompass any structure capable of supporting sealing members and maintaining the desired spacing between glass panes. The spacer body 108 may be constructed from metallic or composite metallic and thermoplastic materials, with specialized surface treatments to ensure durability. The materials may specifically include, but are not limited to, aluminum alloys or stainless steel or composite materials that combine metallic and thermoplastic components. To enhance durability and resist environmental stresses, the spacer body 108 may undergo surface treatments such as, but not limited to, anodization, corrosion-resistant coatings, or polymer encapsulation. This construction and/or treatment of the spacer body 108 ensures that the spacer body 108 maintains its structural and aesthetic integrity beyond the typical lifespan of the insulated glass unit 102.

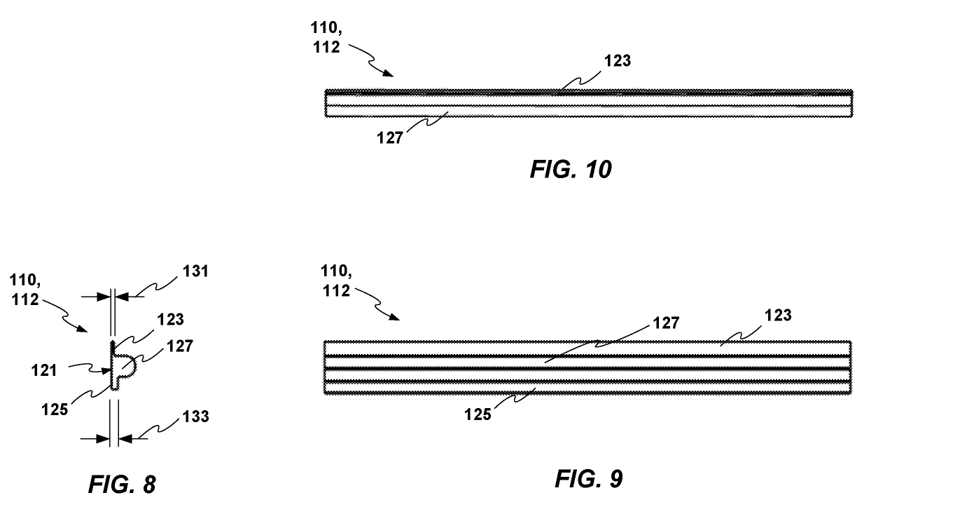

Additionally referring to FIGS. 8-10, the first side sealing member 110 and/or the second side sealing member 112, which as noted above may be mirror images of one another, each include a side sealing member outer wall 121 that defines a first side sealing member flange 123 and a second side sealing member flange 125 each extending in opposite directions from a side sealing member body 127. The first side sealing member flange 123 is adjacent to and/or extends toward the cavity 118 (see, e.g., FIG. 1), while the second side sealing member flange 125 is adjacent to and/or extends toward the outside sealing member 114 and/or the exterior of the insulated glass unit 102 (see, e.g., FIG. 1). The side sealing member body 127 is configured to be sealingly affixed within the first channel 132 or the second channel 134 of the spacer body 108. The first channel 132 and the second channel 134 include any recessed region, groove, slot, cavity, depression, or receiving area defined in an outer surface of the spacer body 108 configured to receive and retain the respective sealing member 110, 112. Each channel 132, 134 may be formed by any suitable means including extrusion, machining, stamping, molding, or assembly of separate components. Each channel 132, 134 may have any suitable cross-sectional profile including rectangular, curved, V-shaped, dovetail, or irregular shapes, and may include additional features such as undercuts, ribs, or surface texturing to enhance retention of the respective sealing member 110, 112. The first side sealing member flange 123 of the first side sealing member 110 sealingly connects a first part of the first side wall portion 124 to the first glass pane 104, while the second side sealing member flange 125 sealingly connects a second part of the first side wall portion 124 to the first glass pane 104. Similarly, the first side sealing member flange 123 of the second side sealing member 112 sealingly connects a first part of the second side wall portion 126 to the second glass pane 106, while the second side sealing member flange 125 sealingly connects a second part of the second side wall portion 126 to the second glass pane 106. The first side sealing member flange 123 and the second side sealing member flange 125 include any extending, projecting, or protruding portion of the respective sealing member 110, 112 that extends outwardly from a central body portion. The first side sealing member flange 123 and the second side sealing member flange 125 may take various forms including a wing, lip, tab, fin, ledge, rim, or any other projection suitable for establishing sealing contact between the respective glass pane 104, 106 and the spacer body 108. A first thickness 131 of the first side sealing member flange 123 is less than a second thickness 133 of the second side sealing member flange 125. For instance, a ratio of the first thickness 131 to the second thickness 133 may be 1:1.1, or 1:1.5, or 1:2, or 1:2.5, or 1:3, or any ratio therebetween. The first side sealing member 110 and the second side sealing member 112 may be formed from a flowable, viscoelastic material such that the first thickness 131 of the first side sealing member flange 123 and the second thickness 133 of the second side sealing member flange 125 may be variable depending on an amount of deflection of the first glass pane 104 and/or the second glass pane 106, as the material may flow between each flange and the side sealing member body 127. The viscoelastic material includes any material exhibiting both viscous and elastic characteristics when undergoing deformation, such that the material may flow under sustained stress while also recovering at least partially when the stress is removed. Suitable examples of the flowable, viscoelastic material of the first side sealing member 110 and the second side sealing member 112 include, but are not limited to, a butyl, rubber, polyisobutylene (PIB), hot-melt butyl, polysulfide sealants, silicone-based sealants, polyurethane sealants, acrylic-based sealants, thermoplastic elastomers, or any other material that remains in a viscous state or semi-vicous state in a range of operating temperatures of the insulated glass unit 102, such as but not limited to a temperature ranging from about -40° F to about 180° F (-40° C to about 82° C).

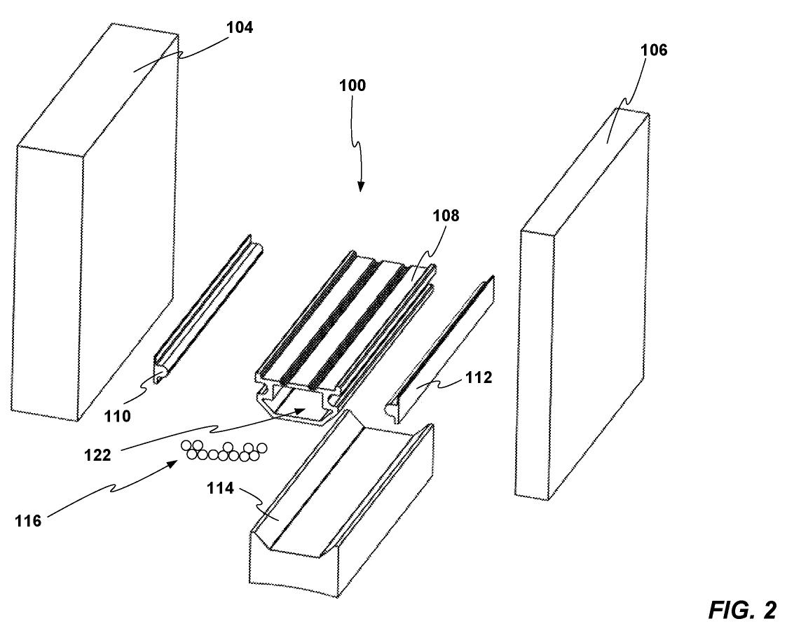

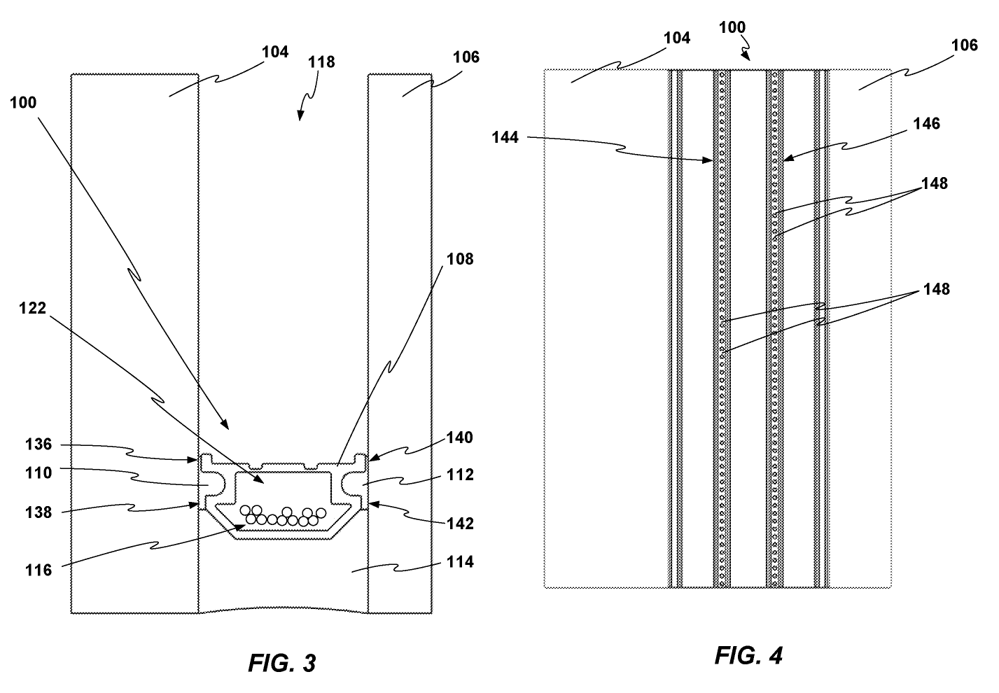

Referring back to FIG. 3, for instance, the first side sealing member flange 123 of the first side sealing member 110 defines a first gap 136 between the first side wall portion 124 and the first glass pane 104, e.g., on one side of the first channel 132 and the side sealing member body 127. And, the second side sealing member flange 125 of the first side sealing member 110 defines a second gap 138 between the first side wall portion 124 and the first glass pane 104, e.g., on an opposite side of the first channel 132 and the side sealing member body 127. Similarly, the first side sealing member flange 123 and the second side sealing member flange 125 of the second side sealing member 112 respectively define a third gap 140 and a fourth gap 142 between the second side wall portion 126 and the second glass pane 106.

As noted, since the first side sealing member 110 and the second side sealing member 112 may be made of a flowable, viscoelastic material, upon deflection, the material of the first side sealing member 110 is able to flow in and out of the first gap 136 and second gap 138 and the material of the second side sealing member 112 is able to flow in and out of the third gap 140 and the fourth gap 142 as necessary during deflection of the glass. For example, the first glass pane 104 may experience external pressure that causes the first glass pane 104 to deflect inward. In response to this deflection, material of the first side sealing member 110 may flow out of the first gap 136 and into the side sealing member body 127, and/or out of the side sealing member body 127 and into the second gap 138, thereby maintaining the seal between the spacer body 108 and the first glass pane 104 even during significant deflection.

Further, due to the first thickness 131 of the first side sealing member flange 123 being less than a second thickness 133 of the second side sealing member flange 125, the second gap 138 and the fourth gap 142 are wider than the first gap 136 and the third gap 140, which allows for greater material flow into or out of the second gap 138 and the fourth gap 142 to enable greater relative deflection of the first glass pane 104 and/or the second glass pane 106 at the exterior ends. In other words, this difference in gap size allows for significant amounts of deflection to occur, e.g., greater than L/175 industry thresholds, in the first glass pane 104 and the second glass pane 106 while still maintaining the seal between the spacer body 108 and the first glass pane 104 and/or the second glass pane 106.

Referring back to FIGS. 4, 5, and 7, in at least aspects of the spacer assembly 100 that include the desiccant 116, the top wall portion 130 of the spacer body 108 includes at least a first top wall channel 144 and a second top wall channel 146 that include a plurality of holes or perforations 148 that allow for communication between the spacer body inner chamber 122 and the cavity 118 . These holes or perforations 148 allow the desiccant 116 located within the spacer body inner chamber 122 to absorb any moisture located within the cavity 118, thereby preventing any damage due to moisture from occurring to the first glass pane 104, the second glass pane 106, the spacer body 108, and/or the insulated glass unit 102. Additionally, in this aspect, the desiccant 116 helps to prevent any loss of the seal provided by the first and second side sealing members 110, 112. The desiccant 116 may include, but is not limited to, materials such as silica gel beads, molecular sieves, and/or any hygroscopic or water-absorbing material or substance. As discussed above, the desiccant 116 actively absorbs moisture from the cavity 118, and additionally prevent condensation and maintain the optical clarity and insulation performance of the insulated glass unit 102 over time. The desiccant chamber or spacer body inner chamber 122 is strategically placed within the spacer body 108 to maximize moisture absorption efficiency. It should be noted that, in some cases, the desiccant 116 may be located only in vertically-oriented portions of the spacer assembly 100 as positioned within the insulated glass unit 102.

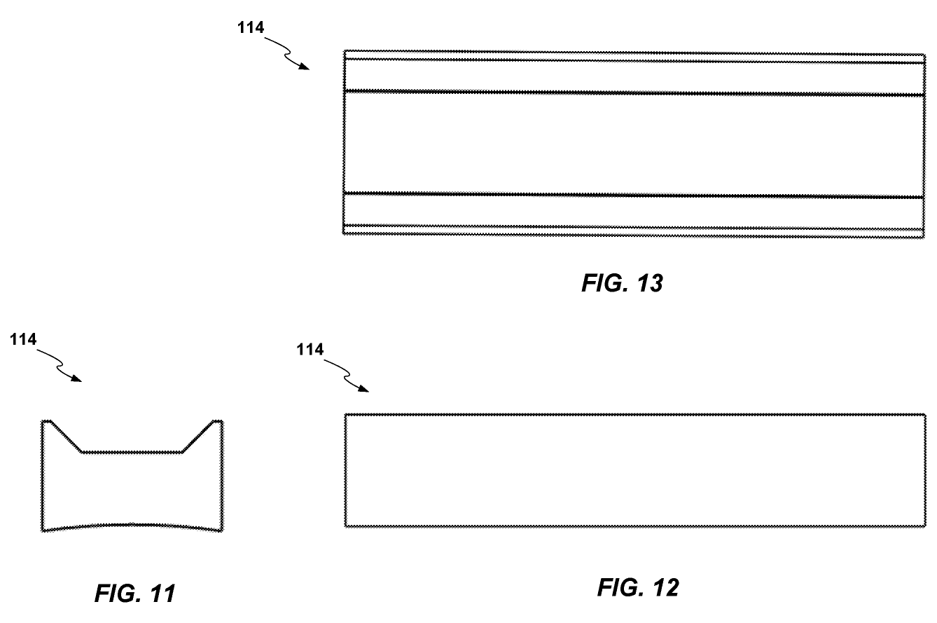

Referring to FIGS. 1-3 and 11-13, the spacer assembly 100, as noted above, may optionally include the outside sealing member 114 configured to sealingly affix to the first glass pane 104 and the second glass pane 106, and preferably to sealingly affix to the first side sealing member 110, the second side sealing member 112, and the bottom wall portion 128 of the spacer body 108. The outside sealing member 114 includes any sealing element, layer, or coating positioned on an exterior side of the spacer assembly 100 opposite the sealed cavity 118, and configured to provide a secondary seal between the glass panes 104 106 and/or the spacer body 108. The outside sealing member 114 may be made of a hydroscopic material, such as but not limited to a material that is 2-parts silicon, single-component silicone, polyurethane, polysulfide, hot-melt adhesives, structural silicone glazing compounds, or any combination thereof, and is configured to maintain the integrity of the sealed cavity 118 as well as prevent thermal communication between the first glass pane 104, the second glass pane 106 and the spacer body 108. The outside sealing member 114 may be applied as a bead, coating, tape, preformed strip or member, or any other suitable form. Further, it should be understood that the first glass pane 104, the second glass pane 106 include any transparent or translucent panel suitable for use in an insulated glass unit 102. Each glass pane 104, 106 may comprise, without limitation, annealed glass, heat-strengthened glass, tempered glass, laminated glass, monolithic glass, low-emissivity (low-E) coated glass, reflective glass, tinted glass, patterned glass, wired glass, chemically strengthened glass, or any combination thereof. The term "glass" as used herein also encompasses glass-like materials including acrylic, polycarbonate, or other transparent polymeric materials suitable for glazing applications.

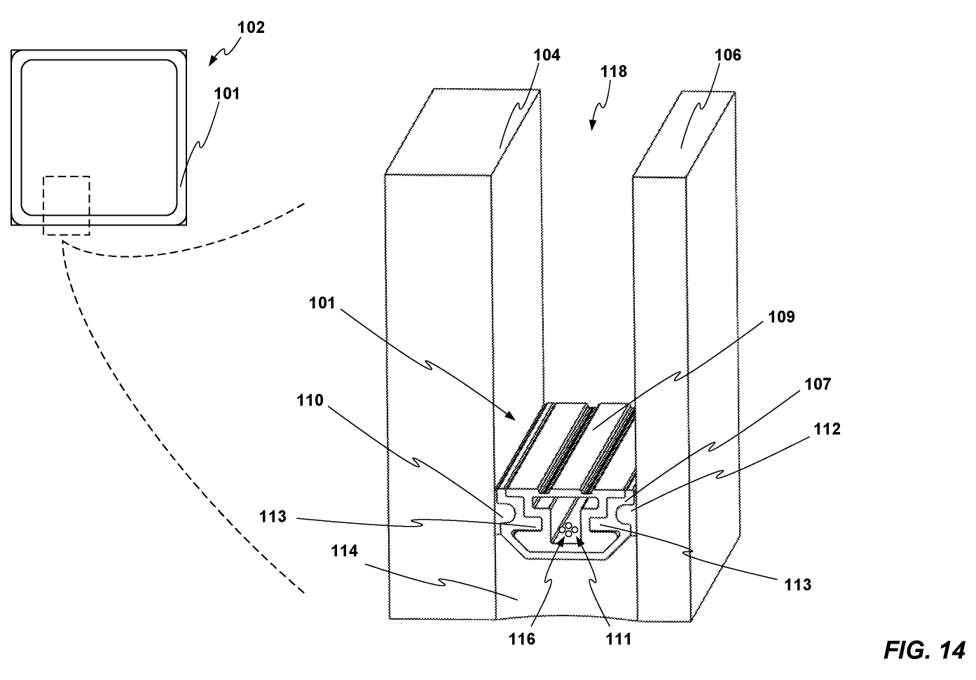

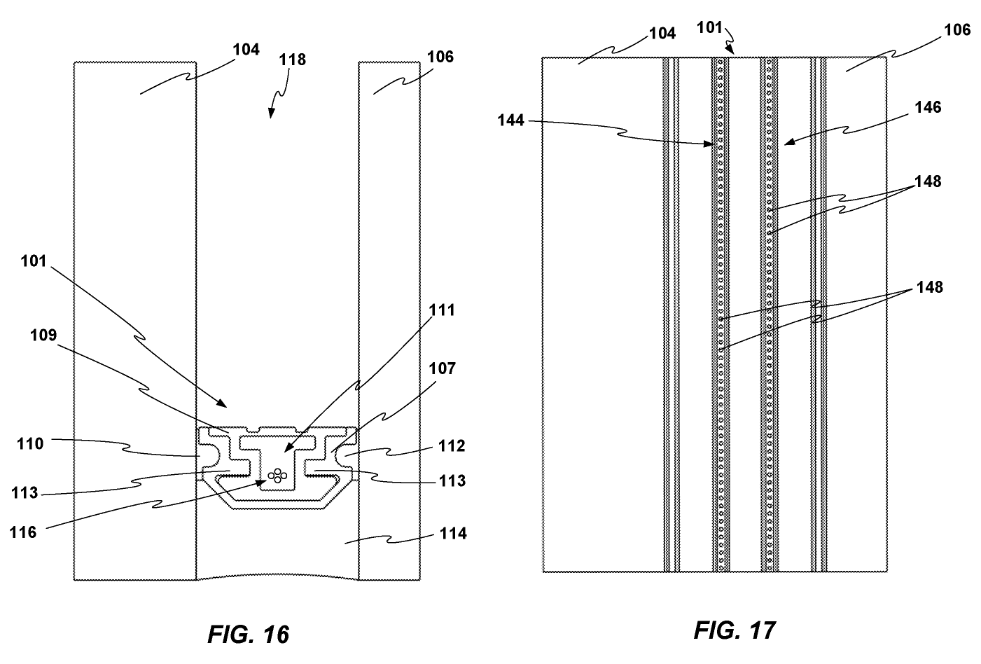

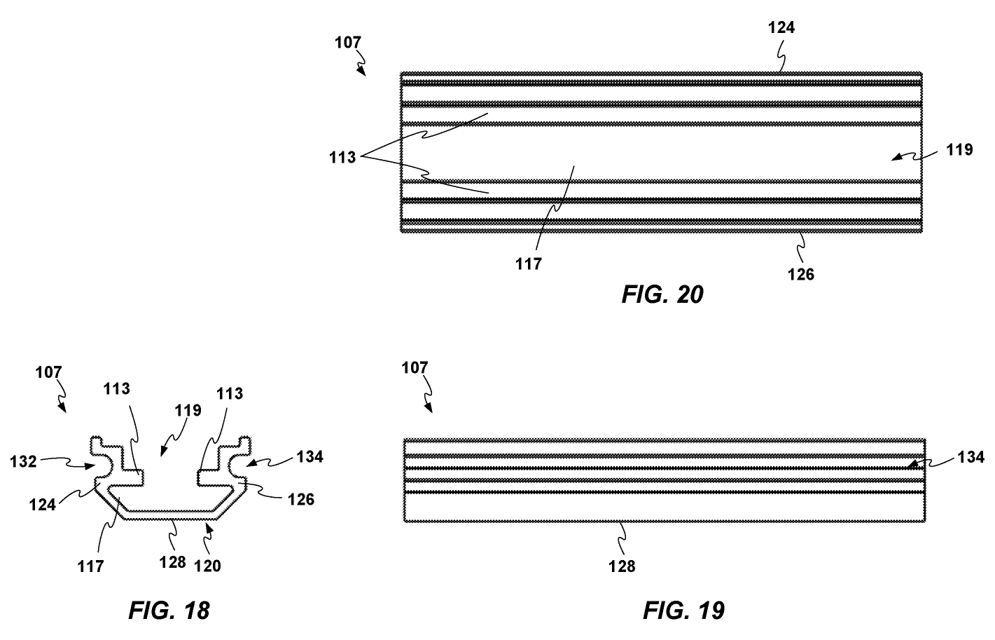

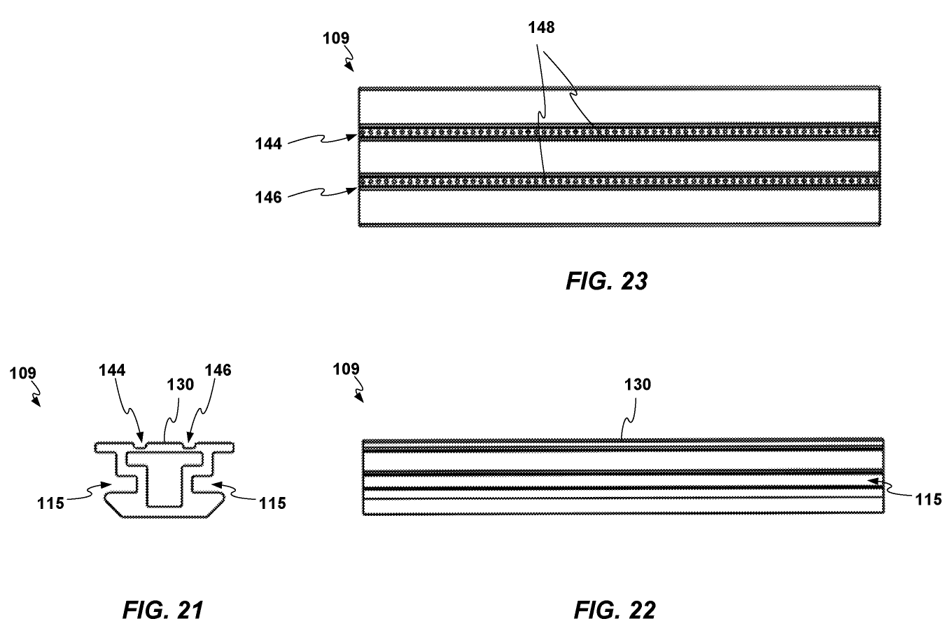

Referring to FIGS. 14-23, in another implementation with an increased thermal insulation construction relative to spacer assembly 100, a spacer assembly 101 also extends along the edges of the insulated glass unit 102 and is sealingly positioned between the first glass pane 104 and the second glass pane 106. The spacer assembly 101 includes a spacer body 107 formed of a first material and a spacer body insert 109 formed of a second material having a lower thermal conductivity than the first material. The spacer body insert 109 includes any component or element positioned within or coupled to the spacer body 107 that provides a thermal break or reduced thermal conductivity path. Similar to the spacer assembly 100, the spacer assembly 101 further includes the first side sealing member 110, the second side sealing member 112, optionally the outside sealing member 114, and also optionally the desiccant 116, along with corresponding structures in the spacer body 107 and/or the spacer body insert 109 similar to those described above with respect to the spacer body 108.

For example, but not limited hereto, the spacer body 107 may be constructed from metallic or composite metallic and thermoplastic materials, optionally including specialized surface treatments to ensure durability. The materials may specifically include, but are not limited to, aluminum alloys or stainless steel or composite materials that combine metallic and thermoplastic components. The spacer body insert 109 may be formed from a material configured to prevent thermal communication, such as but not limited to a silicone or a rubber material, an ethylene propylene diene monomer (EPDM) rubber, neoprene, polyurethane foam, polystyrene, polyethylene, thermoplastic structural foam, fiberglass-reinforced plastic, or any other material having a lower thermal conductivity than the material of the primary spacer body 107. The spacer body insert 109 may be integrally formed with the spacer body 107, press-fit, adhesively bonded, mechanically fastened, or otherwise coupled thereto. The lower thermal conductivity of the material of the spacer body insert 109 allows the spacer body insert 109 to prevent thermal communication between a first side of the insulated glass unit 102 to a second side of the insulated glass unit 102. The optional surface treatment of spacer body 107 (and/or spacer body 108 as described herein) includes any process or coating applied to modify the surface properties of the spacer body 107, 108. Surface treatments include, but are not limited to, anodization (including clear, colored, or hard anodization), chromate conversion coating, phosphate coating, electroplating, electroless plating, powder coating, wet paint coating, polymer encapsulation, ceramic coating, plasma treatment, laser surface texturing, chemical etching, passivation, and any other treatment that enhances corrosion resistance, adhesion, durability, or aesthetic appearance of the spacer body 107, 108.

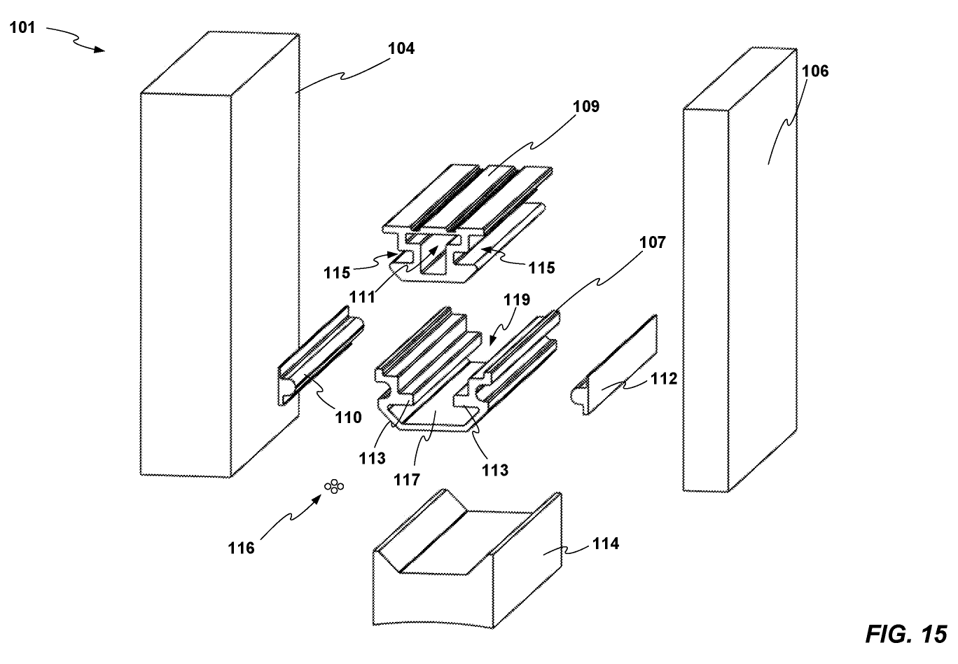

The spacer assembly 101 operates similar to the spacer assembly 100, however, the spacer body 107 includes one or more internal walls 117 that define a channel 119 configured to receive the spacer body insert 109 (see, e.g., FIGS. 15, 18, and 20), which in some aspects may include a spacer body insert inner chamber 111 to contain the desiccant 116. The spacer body insert 109 acts as a spacer body top portion, and in aspects where the spacer assembly 101 includes the desiccant 116, the spacer body insert 109 includes the first top wall channel 144 and the second top wall channel 146 having the plurality of holes or perforations 148 that allow for communication between the spacer body insert inner chamber 111 and the cavity 118 between the first glass pane 104 and the second glass pane 106. .

The spacer body 107 further includes at least two internal flanges 113 configured to position and hold the spacer body insert 109 within the spacer body 107. For example, the at least two internal flanges 113 are configured to be received in a corresponding at least two external slots 115 defined in the outer wall of the spacer body insert 109.

In other aspects, the present disclosure can be implemented according to one or more of the following clauses.

Clause 1. An insulated glass unit spacer assembly, comprising: a spacer body having a first side wall portion at a first side of the spacer body and a second side wall portion at a second side of the spacer body, wherein the first side wall portion defines a first channel and wherein the second side wall portion defines second channel; a first side sealing member located within the first channel and configured to sealingly affix the first side wall portion to a first glass pane; and a second side sealing member located within the second channel and configured to affix the second side wall portion to a second glass pane; wherein both of the first side sealing member and the second side sealing member include a first side sealing member flange and a second side sealing member flange each extending in opposite directions from a side sealing member body; and wherein a first thickness of each first side sealing member flange is less than a second thickness of each second side sealing member flange.

Clause 2. The insulated glass unit spacer assembly of clause 1, wherein a ratio of the first thickness to the second thickness is 1:1.1, or 1:1.5, or 1:2, or 1:2.5, or 1:3, or any ratio therebetween.

Clause 3. The insulated glass unit spacer assembly of any preceding clause, wherein the first side sealing member and the second side sealing member comprise a viscoelastic material.

Clause 4. The insulated glass unit spacer assembly of any preceding clause, further comprising: a spacer body insert affixed within the spacer body, wherein the spacer body insert has a lower thermal conductivity than the spacer body.

Clause 5. The insulated glass unit spacer assembly of clause 4, wherein the spacer body insert includes one or more internal walls that define a channel, wherein the spacer body insert is located within the channel.

Clause 6. The insulated glass unit spacer assembly of clause 4, further comprising: a desiccant contained within the spacer body insert.

Clause 7. The insulated glass unit spacer assembly of any preceding clause, further comprising: an outside sealing member affixed to a bottom wall portion of the spacer body and configured to sealingly affix the first glass pane and the second glass pane.

Clause 8. The insulated glass unit spacer assembly of any preceding clause, further comprising: a desiccant contained within the spacer body.

Clause 9. The insulated glass unit spacer assembly of any preceding clause, wherein at least the first side sealing member and the second side sealing member are configured to provide a dynamic movement mechanism to accommodate glass edge deflection beyond L/175 standards without compromising a sealing integrity of a cavity between the first glass pane and the second glass pane.

Clause 10. An insulated glass unit, comprising: a first glass pane; a second glass pane; a spacer assembly sealingly connecting the first glass pane and the second glass pane, wherein the spacer assembly includes: a spacer body having a first side wall portion at a first side of the spacer body and a second side wall portion at a second side of the spacer body, wherein the first side wall portion defines a first channel and wherein the second side wall portion defines second channel; a first side sealing member located within the first channel and sealingly affixed between the first side wall portion and the first glass pane; and a second side sealing member located within the second channel and sealingly affixed between the second side wall portion and the second glass pane; wherein both of the first side sealing member and the second side sealing member include a first side sealing member flange and a second side sealing member flange each extending in opposite directions from a side sealing member body; and wherein a first thickness of each first side sealing member flange is less than a second thickness of each second side sealing member flange.

Clause 11. The insulated glass unit of clause 10, wherein a ratio of the first thickness to the second thickness is 1:1.1, or 1:1.5, or 1:2, or 1:2.5, or 1:3, or any ratio therebetween.

Clause 12. The insulated glass unit of any preceding clause, wherein the first side sealing member and the second side sealing member comprise a viscoelastic material.

Clause 13. The insulated glass unit of any preceding clause, further comprising: a spacer body insert affixed within the spacer body, wherein the spacer body insert has a lower thermal conductivity than the spacer body.

Clause 14. The insulated glass unit of clause 13, wherein the spacer body insert includes one or more internal walls that define a channel, wherein the spacer body insert is located within the channel.

Clause 15. The insulated glass unit of clause 13, further comprising: a desiccant contained within the spacer body insert.

Clause 16. The insulated glass unit of any preceding clause, further comprising: an outside sealing member affixed to a bottom wall portion of the spacer body and configured to sealingly affix the first glass pane and the second glass pane.

Clause 17. The insulated glass unit of any preceding clause, further comprising: a desiccant contained within the spacer body.

Clause 18. The insulated glass unit of any preceding clause, wherein at least the first side sealing member and the second side sealing member are configured to provide a dynamic movement mechanism to accommodate glass edge deflection beyond L/175 standards without compromising a sealing integrity of a cavity between the first glass pane and the second glass pane.

Clause 19. The insulated glass unit of any preceding clause, wherein the spacer body includes a surface treatment of anodization or corrosion-resistant coatings.

Clause 20. The insulated glass unit of any preceding clause, wherein the spacer body is made of a metallic or composite metallic and thermoplastic material.

In general, the description of the aspects disclosed should be considered as being illustrative in all respects and not being restrictive. The scope of the present disclosure is shown by the claims rather than by the above description, and is intended to include meanings equivalent to the claims and all changes in the scope. While preferred aspects of the disclosure have been described above, it is to be understood that variations and modifications will be apparent to those skilled in the art without departing from the scope and spirit of the disclosure.

What is claimed is:

1. An insulated glass unit spacer assembly, comprising:
a spacer body having a first side wall portion at a first side of the spacer body and a second side wall portion at a second side of the spacer body, wherein the first side wall portion defines a first channel and wherein the second side wall portion defines second channel;
a first side sealing member located within the first channel and configured to sealingly affix the first side wall portion to a first glass pane; and
a second side sealing member located within the second channel and configured to affix the second side wall portion to a second glass pane;
wherein both of the first side sealing member and the second side sealing member include a first side sealing member flange and a second side sealing member flange each extending in opposite directions from a side sealing member body; and
wherein a first thickness of each first side sealing member flange is less than a second thickness of each second side sealing member flange.

2. The insulated glass unit spacer assembly of claim 1, wherein a ratio of the first thickness to the second thickness is 1:1.1, or 1:1.5, or 1:2, or 1:2.5, or 1:3, or any ratio therebetween.

3. The insulated glass unit spacer assembly of claim 1, wherein the first side sealing member and the second side sealing member comprise a viscoelastic material.

4. The insulated glass unit spacer assembly of claim 1, further comprising:
a spacer body insert affixed within the spacer body, wherein the spacer body insert has a lower thermal conductivity than the spacer body.

5. The insulated glass unit spacer assembly of claim 4, wherein the spacer body insert includes one or more internal walls that define a channel, wherein the spacer body insert is located within the channel.

6. The insulated glass unit spacer assembly of claim 4, further comprising:
a desiccant contained within the spacer body insert.

7. The insulated glass unit spacer assembly of claim 1, further comprising:
an outside sealing member affixed to a bottom wall portion of the spacer body and configured to sealingly affix the first glass pane and the second glass pane.

8. The insulated glass unit spacer assembly of claim 1, further comprising:
a desiccant contained within the spacer body.

9. The insulated glass unit spacer assembly of claim 1, wherein at least the first side sealing member and the second side sealing member are configured to provide a dynamic movement mechanism to accommodate glass edge deflection beyond L/175 standards without compromising a sealing integrity of a cavity between the first glass pane and the second glass pane.

10. An insulated glass unit, comprising:
a first glass pane;
a second glass pane;
a spacer assembly sealingly connecting the first glass pane and the second glass pane, wherein the spacer assembly includes:
a spacer body having a first side wall portion at a first side of the spacer body and a second side wall portion at a second side of the spacer body, wherein the first side wall portion defines a first channel and wherein the second side wall portion defines second channel;
a first side sealing member located within the first channel and sealingly affixed between the first side wall portion and the first glass pane; and
a second side sealing member located within the second channel and sealingly affixed between the second side wall portion and the second glass pane;
wherein both of the first side sealing member and the second side sealing member include a first side sealing member flange and a second side sealing member flange each extending in opposite directions from a side sealing member body; and
wherein a first thickness of each first side sealing member flange is less than a second thickness of each second side sealing member flange.

11. The insulated glass unit of claim 10, wherein a ratio of the first thickness to the second thickness is 1:1.1, or 1:1.5, or 1:2, or 1:2.5, or 1:3, or any ratio therebetween.

12. The insulated glass unit of claim 10, wherein the first side sealing member and the second side sealing member comprise a viscoelastic material.

13. The insulated glass unit of claim 10, further comprising:
a spacer body insert affixed within the spacer body, wherein the spacer body insert has a lower thermal conductivity than the spacer body.

14. The insulated glass unit of claim 13, wherein the spacer body insert includes one or more internal walls that define a channel, wherein the spacer body insert is located within the channel.

15. The insulated glass unit of claim 13, further comprising:
a desiccant contained within the spacer body insert.

16. The insulated glass unit of claim 10, further comprising:
an outside sealing member affixed to a bottom wall portion of the spacer body and configured to sealingly affix the first glass pane and the second glass pane.

17. The insulated glass unit of claim 10, further comprising:
a desiccant contained within the spacer body.

18. The insulated glass unit of claim 10, wherein at least the first side sealing member and the second side sealing member are configured to provide a dynamic movement mechanism to accommodate glass edge deflection beyond L/175 standards without compromising a sealing integrity of a cavity between the first glass pane and the second glass pane.

19. The insulated glass unit of claim 10, wherein the spacer body includes a surface treatment of anodization or corrosion-resistant coatings.

20. The insulated glass unit of claim 10, wherein the spacer body is made of a metallic or composite metallic and thermoplastic material.
